(19) United States
(12) Patent Application Publication
(10) Pub. No.: US 2026/0079811 A1
(43) Pub. Date: Mar. 19, 2026

(54) METHOD AND SYSTEM FOR MONITORING AND ENHANCING THE RELIABILITY OF A CUSTOMER JOURNEY

(71) Applicant: JPMorgan Chase Bank, N.A., New York, NY (US)

(72) Inventors: Venkata Mohit TAMANAMPUDI, New Castle, DE (US); Jayaprakash MOSES, Greenville, DE (US); Priya Darshini AMARA, Glen Mills, PA (US); Matthew JENKINS, Montclair, NJ (US); Aastha PANDEY, Bear, DE (US)

(73) Assignee: JPMorgan Chase Bank, N.A., New York, NY (US)

(21) Appl. No.: 19/047,100

(22) Filed: Feb. 6, 2025

Related U.S. Application Data
(60) Provisional application No. 63/696,738, filed on Sep. 19, 2024.

(51) Int. Cl. G06F 11/34; G06F 9/54

(52) U.S. Cl. CPC G06F 11/3438; G06F 9/54

(57) ABSTRACT

A method and a system for ensuring reliability of a customer journey with a platform are provided. The method includes: receiving first data that relates to an interaction of a customer with the platform; collecting historical metadata that relates to a plurality of reliability-based metrics for each application programming interface (API) that relates to the platform; determining, based on the collected metadata, a corresponding threshold metric value for each respective reliability-based metric from among the plurality of reliability-based metrics; comparing the first data to each corresponding threshold metric value; when the first data exceeds at least one corresponding threshold metric value: identifying, based on a result of the comparing, a corresponding issue; and generating, based on the identifying, an alert.

### CROSS-REFERENCE TO RELATED APPLICATIONS

This application claims priority benefit from U.S. Provisional Application No. 63/696,738, filed on Sep. 19, 2024, in the U.S. Patent and Trademark Office, which is hereby incorporated by reference in its entirety.

### BACKGROUND

### 1. Field of the Disclosure

This technology generally relates to methods and systems for ensuring reliability of a customer journey with a platform, and more particularly to methods and systems for identifying potential reliability issues regarding user interactions within a platform and generating potential actions to address the identified issues.

### 2. Background Information

In the rapidly evolving landscape of digital services, ensuring the reliability of critical customer journeys has become a paramount concern for businesses. As organizations transition to microservices architectures, they face unprecedented challenges in maintaining seamless user experiences across complex and distributed systems.

In the context of modern digital enterprises, ensuring the reliability of critical customer journeys is not just a technical necessity but a business imperative. This is underscored by the significant challenges faced by organizations in maintaining the seamless operation of their digital services. These challenges include: a high volume of critical issues; wide-reaching impact on customers; extended downtime; and prolonged detection and mitigation.

Regarding the high volume of critical issues, organizations often experience a high number of priority severity tickets. For instance, handling 400+ priority severity tickets may indicate a substantial burden on the IT support and operations teams. Each of these tickets represents a critical issue that requires immediate attention and resolution to avoid widespread disruptions.

Regarding the wide-reaching impact on customers, when critical financial applications experience downtime, the impact can be massive. In a past scenario, millions of customers were affected by the downtime of a critical financial application. This widespread impact not only affects customer satisfaction but also erodes trust in the organization's ability to provide reliable services.

Regarding extended downtime, in the above-mentioned past scenario, the critical financial application in question was down for more than 15 hours. Such extended downtime has severe implications, including financial losses, regulatory repercussions, and damage to the organization's reputation. For financial applications, even minor downtimes can have cascading effects on transactions, customer trust, and overall market standing.

Regarding prolonged detection and mitigation, the mean time to detect (MTTD) and mean time to mitigate (MTTM), the above-mentioned scenario, were both more than 16 hours. This extended response time poses a significant challenge for businesses, as prolonged detection and mitigation times lead to extended periods of service unavailability, compounding the negative impacts on customers and business operations.

These challenges highlight the need for a robust solution that can significantly improve the detection and resolution of critical issues. Traditional monitoring and response systems often fall short due to their inability to provide real-time insights and predictive analytics. The fragmentation of monitoring tools across different components of the IT infrastructure further exacerbates the problem, making it difficult to obtain a comprehensive view of the system's health and performance.

Additionally, the shift from monolithic architectures to microservice architectures has revolutionized how applications are built and managed, offering significant advantages in scalability, flexibility, and development speed. However, this evolution also brings substantial challenges, particularly in the areas of logging, observability, and monitoring. These challenges are amplified in critical customer journeys that span multiple application programming interfaces (APIs) and involve multiple teams, each with its own monitoring practices. The complexity of managing and ensuring the reliability of these journeys is compounded by several key issues.
1) Increased Logging and Observability Data: a) Volume of Data: microservices generate a significant amount of log and telemetry data. Managing this vast amount of data requires robust logging and observability solutions capable of handling high throughput and providing actionable insights. b) Distributed Systems: In a microservices environment, logs and metrics are distributed across numerous services, making it difficult to correlate data and trace the flow of requests end-to-end.
2) Complexity of Monitoring: a) Diverse Monitoring Tools: different teams often use different monitoring tools and methodologies, leading to a lack of standardization. Tools like Prometheus, Grafana, Datadog, New Relic, and others may be used independently, creating silos of information. b) Inconsistent Criteria and Thresholds: each team might define its own criteria and thresholds for monitoring, resulting in inconsistency and confusion. This makes it challenging to get a unified view of the system's health and performance.
3) Critical Customer Journeys Across Multiple APIs: a) Multiple Teams Involvement: critical customer journeys often span multiple APIs, each managed by different teams. Coordination and communication between these teams are crucial but often lacking. b) Varied Monitoring Methodologies: each team may employ different monitoring methodologies, making it difficult to aggregate and analyze data cohesively. This results in fragmented visibility and delayed response to issues.
4) Heterogeneous Reliability Metrics: a) Different API Methods: each API may have various methods with different reliability metrics. Setting appropriate thresholds for these metrics is complex due to the varied nature of the methods and their respective importance in the customer journey. b) Dynamic Environments: in a microservices architecture, services are frequently updated, scaled, and modified. Keeping monitoring configurations up to date in such a dynamic environment is a continuous challenge. c) Setting Thresholds for Monitoring. d) Complexity of Thresholds: determining appropriate thresholds for alerting is complicated due to the diversity of services and their specific reliability requirements. Overly aggressive thresholds can lead to alert fatigue, while too lenient thresholds may result in missed critical issues. e) Adaptive Thresholds: static thresholds may not be effective in dynamic environments. Adaptive thresholds that adjust based on historical data and current conditions are needed but are often difficult to implement and maintain.

Accordingly, there is a need for identifying potential reliability issues regarding user interactions within a platform and generating potential actions to address the identified issues.

### SUMMARY

The present disclosure, through one or more of its various aspects, embodiments, and/or specific features or sub-components, provides, inter alia, various systems, servers, devices, methods, media, programs, and platforms for identifying potential reliability issues regarding user interactions within a platform and generating potential actions to address the identified issues.

According to an aspect of the present disclosure, a method for ensuring reliability of a customer journey with a platform is provided. The method may be implemented by at least one processor. The method may include: receiving, by the at least one processor, first data that relates to an interaction of a customer with the platform; collecting, by the at least one processor, historical metadata that relates to a plurality of reliability-based metrics for each API that relates to the platform; determining, by the at least one processor based on the collected metadata, a corresponding threshold metric value for each respective reliability-based metric from among the plurality of reliability-based metrics; comparing, by the at least one processor, the first data to each corresponding threshold metric value; when the first data exceeds at least one corresponding threshold metric value: identifying, by the at least one processor and based on a result of the comparing, a corresponding issue; and generating, by the at least one processor and based on the identifying, an alert.

The plurality of reliability-based metrics may include at least one from among a response time, an error rate, an availability of the system, a traffic level, a throughput, a latency, a number of insufficient alerts issued, a number of redundant alerts issued, a number of false positives, a number of false negatives, a fault tolerance, a delay tolerance, an uptime, a request rate, a time to detect, a time to respond, and a time to mitigate.

The determining of the corresponding threshold metric value may include applying an Isolation Forest algorithm to the collected historical metadata in order to automatically determine the corresponding threshold metric value by constructing at least one decision tree and isolating corresponding outlier data points.

The method may further include when the first data exceeds the at least one corresponding threshold metric value, transmitting the alert to a corresponding API owner of a respective API that is associated with the identified corresponding issue.

The method may further include: when the first data exceeds the at least one corresponding threshold metric value: applying a large language model (LLM) to extract information regarding the identified corresponding issue; generating, by the at least one processor using the LLM and based on the extracted information, a summary regarding the corresponding issue; and generating, by the at least one processor using the LLM, an approach to address the corresponding issue.

The method may further include: calculating a corresponding mean for each respective reliability-based metric; and calculating a corresponding standard deviation for each respective reliability-based metric. The determining of the corresponding threshold metric value may include setting each corresponding threshold metric value to a predetermined number of the corresponding standard deviations from the corresponding mean.

The method may further include: retrieving, by the at least one processor, a universal trace identification for the interaction of the customer with the customer platform; and monitoring, by the at least one processor using the universal trace identification, each interaction of the customer with each API during the interaction of the customer with the platform. The universal trace identification may be recognizable by each API that relates to the customer platform.

The method may further include displaying, by the at least one processor via a graphical user interface (GUI), each identified corresponding issue and a summary of the first data that relates to the plurality of reliability-based metrics.

The method may further include when the first data exceeds at least one corresponding threshold metric value, applying an LLM to automatically resolve the identified corresponding issue.

According to another embodiment, a computing apparatus for ensuring reliability of a customer journey with a platform is provided. The computing apparatus includes a processor; a memory; and a communication interface coupled to each of the processor and the memory. The processor may be configured to: receive first data that relates to an interaction of a customer with the platform; collect historical metadata that relates to a plurality of reliability-based metrics for each API that relates to the platform; determine, based on the collected metadata, a corresponding threshold metric value for each respective reliability-based metric from among the plurality of reliability-based metrics; compare the first data to each corresponding threshold metric value; when the first data exceeds at least one corresponding threshold metric value: identify, based on a result of the comparing, a corresponding issue; and generate, based on a result of the identifying, an alert.

The plurality of reliability-based metrics may include at least one from among a response time, an error rate, an availability of the system, a traffic level, a throughput, a latency, a number of insufficient alerts issued, a number of redundant alerts issued, a number of false positives, a number of false negatives, a fault tolerance, a delay tolerance, an uptime, a request rate, a time to detect, a time to respond, and a time to mitigate.

The determining of the corresponding threshold metric value may include applying an Isolation Forest algorithm to the collected historical metadata in order to automatically determine the corresponding threshold metric value by constructing at least one decision tree and isolating corresponding outlier data points.

The processor may be further configured to: when the first data exceeds the at least one corresponding threshold metric value, transmit the alert to a corresponding API owner of a respective API that is associated with the identified corresponding issue.

The processor may be further configured to: when the first data exceeds the at least one corresponding threshold metric value: apply an LLM to extract information regarding the identified corresponding issue; generate, via the LLM and based on the extracted information, a summary regarding the corresponding issue; and generate, via the LLM, an approach to address the corresponding issue.

The processor may be further configured to: calculate a corresponding mean for each respective reliability-based metric; and calculate a corresponding standard deviation for each respective reliability-based metric. The determining of the corresponding threshold metric value may include setting each corresponding threshold metric value to a predetermined number of the corresponding standard deviations from the corresponding mean.

The processor may be further configured to: retrieve a universal trace identification for the interaction of the customer with the customer platform, wherein the universal trace identification is recognizable by each API that relates to the customer platform; and monitor, via the universal trace identification, each interaction of the customer with each API during the interaction of the customer with the platform.

The processor may be further configured to display, via a GUI, each identified corresponding issue and a summary of the first data that relates to the plurality of reliability-based metrics.

The processor may be further configured to: when the first data exceeds at least one corresponding threshold metric value, apply an LLM to automatically resolve the identified corresponding issue.

According to yet another embodiment, a non-transitory computer readable storage medium storing instructions for ensuring reliability of a customer journey with a platform is provided. The storage medium includes a set of executable code which, when executed by a processor, may cause the processor to: receive first data that relates to an interaction of a customer with the platform; collect historical metadata that relates to a plurality of reliability-based metrics for each API that relates to the platform; determine, based on the collected metadata, a corresponding threshold metric value for each respective reliability-based metric from among the plurality of reliability-based metrics; compare the first data to each corresponding threshold metric value; when the first data exceeds at least one corresponding threshold metric value: identify, based on a result of the comparing, a corresponding issue; and generate, based on a result of the identifying, an alert.

The plurality of reliability-based metrics may include at least one from among a response time, an error rate, an availability of the system, a traffic level, a throughput, a latency, a number of insufficient alerts issued, a number of redundant alerts issued, a number of false positives, a number of false negatives, a fault tolerance, a delay tolerance, an uptime, a request rate, a time to detect, a time to respond, and a time to mitigate.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for identifying potential reliability issues regarding user interactions within a platform and generating potential actions to address the identified issues, according to an embodiment.

FIG. 2 illustrates a diagram of a network environment for identifying potential reliability issues regarding user interactions within a platform and generating potential actions to address the identified issues, according to an embodiment.

FIG. 3 illustrates a system diagram of a system for identifying potential reliability issues regarding user interactions within a platform and generating potential actions to address the identified issues, according to an embodiment.

FIG. 4 illustrates a process diagram of a process for identifying potential reliability issues regarding user interactions within a platform and generating potential actions to address the identified issues, according to an embodiment.

FIG. 5 illustrates an architectural flow diagram of a process for identifying potential reliability issues regarding user interactions within a platform and generating potential actions to address the identified issues, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units and/or modules of the example embodiments may be physically combined into more complex blocks, units, and/or modules without departing from the scope of the present disclosure.

A system or method disclosed herein improves reliability of customer journeys in digital platforms. Particularly, the system receives data that relates to an interaction between a customer and a digital platform, such as a business website or application. The data relates to each underlying system that makes up the digital platform. The system then collects historical reliability data for each respective underlying system. The system then determines threshold reliability metrics for each underlying system based on the historical data. Next, the system compares the respective received underlying system data to each corresponding determined threshold value. If the system determines that the respective data exceeds the corresponding threshold value, the systems identifies that there is an issue and generates an alert.

By leveraging advanced analytics and machine learning (ML) algorithms, the system can predict potential disruptions, identify root causes of reliability issues, and recommend proactive measures to mitigate risks and improve reliability of customer journeys. The system may also offer a bird's-eye view across all lines of business, applications, teams, and microservices, which may foster collaboration. This unified approach not only improves operational efficiency but also ensures a consistent and high-quality user experience. Moreover, the systems integration of ambient AI agents into reliability monitoring frameworks represents a significant advancement in ensuring the robustness of critical customer journeys, ultimately leading to improved customer satisfaction and business success. Furthermore, by leveraging AI within the system, businesses can gain deeper insights into user interactions, predict and prevent potential disruptions, and optimize the overall customer experience. The system may also utilize a dashboard that provides a comprehensive overview of user interactions across all business lines, applications, teams, and microservices. This dashboard not only identifies potential reliability issues but also facilitates proactive measures to address them, thereby ensuring a seamless user experience. Additionally, to address the complexities of monitoring and ensuring the reliability of critical customer journeys in a microservices architecture, the system may utilize an AI-driven approach to automate threshold setting. This solution leverages the Isolation Forest algorithm for anomaly detection and employs statistical methods to establish and monitor reliability metrics.

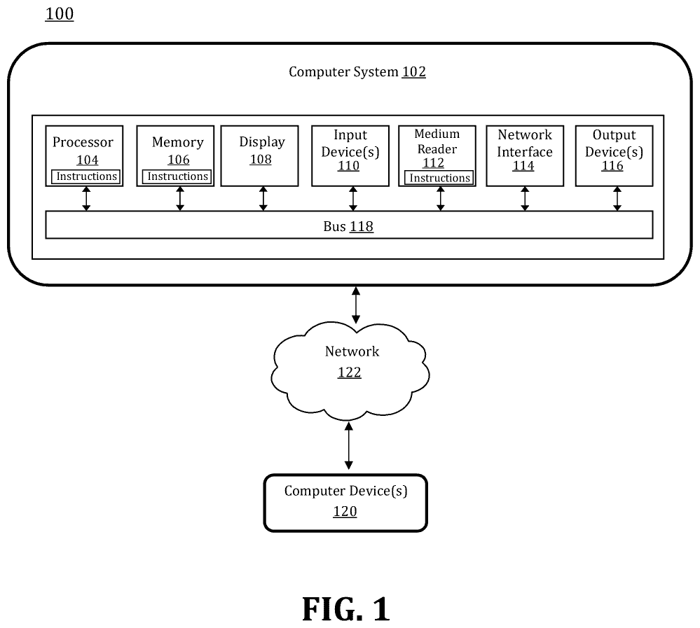

FIG. 1 is a system 100 for identifying potential reliability issues regarding user interactions within a platform and generating potential actions to address the identified issues, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the customer journey reliability module implemented by the system 100 may allow for identifying potential reliability issues regarding user interactions within a platform and generating potential actions to address the identified issues. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

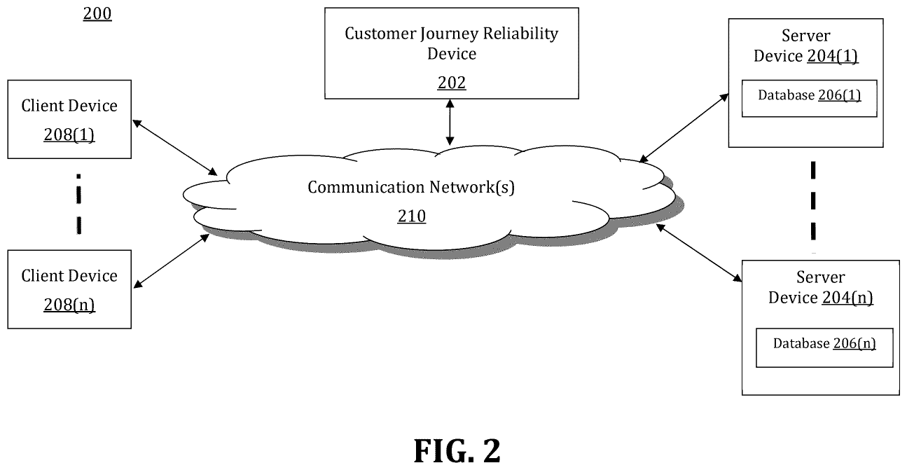

Referring to FIG. 2, a schematic of a network environment 200 for identifying potential reliability issues regarding user interactions within a platform and generating potential actions to address the identified issues is illustrated.

In some embodiments, the above-described problems associated with conventional tools may be overcome by implementing a customer journey reliability device 202 as illustrated in FIG. 2 that may be configured for identifying potential reliability issues regarding user interactions within a platform and generating potential actions to address the identified issues, but the disclosure is not limited thereto.

The customer journey reliability device 202 may include one or more computer systems 102, as described with respect to FIG. 1, which in aggregate provide the necessary functions.

The customer journey reliability device 202 may store one or more applications that can include executable instructions that, when executed by the customer journey reliability device 202, cause the customer journey reliability device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the customer journey reliability device 202 itself, may be located in virtual server(s) running in a cloud-based computing environment rather than being tied to one or more specific physical network computing devices. Also, the application(s) may be running in one or more virtual machines (VMs) executing on the customer journey reliability device 202. Additionally, in one or more embodiments of this technology, virtual machine(s) running on the customer journey reliability device 202 may be managed or supervised by a hypervisor.

In the network environment 200 of FIG. 2, the customer journey reliability device 202 may be coupled to a plurality of server devices 204(1)-204(n) that hosts a plurality of databases 206(1)-206(n), and also to a plurality of client devices 208(1)-208(n) via communication network(s) 210. A communication interface of the customer journey reliability device 202, such as the network interface 114 of the computer system 102 of FIG. 1, operatively couples and communicates between the customer journey reliability device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the customer journey reliability device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The customer journey reliability device 202 may be a standalone device or integrated with one or more other devices or apparatuses, such as one or more of the server devices 204(1)-204(n), for example. In one example, the customer journey reliability device 202 may be hosted by one of the server devices 204(1)-204(n), and other arrangements are also possible. Moreover, one or more of the devices of the customer journey reliability device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the authentication device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the customer journey reliability device 202 that may identify potential reliability issues regarding user interactions within a platform and generate potential actions to address the identified issues, but the disclosure is not limited thereto.

The client devices 208(1)-208(n) may run interface applications, such as standard web browsers or standalone client applications, which may provide an interface to communicate with the customer journey reliability device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the customer journey reliability device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the customer journey reliability device 202, the server devices 204(1)-204(n), or the client devices 208(1)-208(n), for example, may be configured to operate as virtual instances on the same physical machine. For example, one or more of the customer journey reliability devices 202, the server devices 204(1)-204(n), or the client devices 208(1)-208(n) may operate on the same physical device rather than as separate devices communicating through communication network(s) 210. Additionally, there may be more or fewer customer journey reliability devices 202, server devices 204(1)-204(n), or client devices 208(1)-208(n) than illustrated in FIG. 2. In some embodiments, the customer journey reliability device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

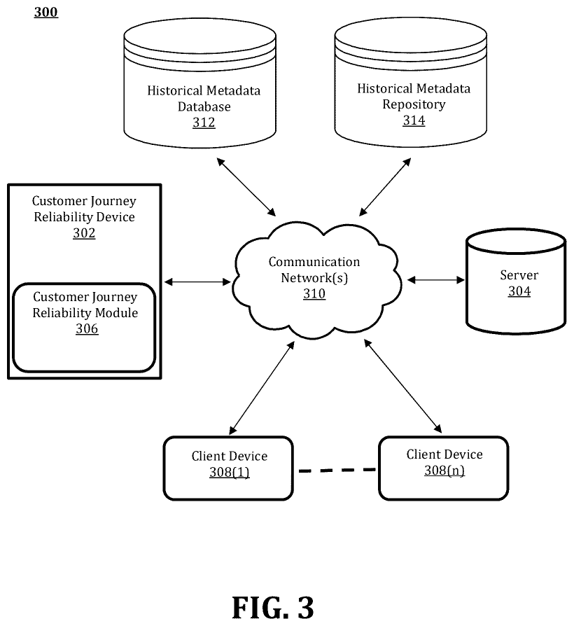

FIG. 3 illustrates a system diagram for identifying potential reliability issues regarding user interactions within a platform and generating potential actions to address the identified issues, in accordance with an embodiment.

As illustrated in FIG. 3, the system 300 may include a customer journey reliability device 302 within which a customer journey reliability module 306 is embedded, a server 304, a historical metadata database 312, a historical metadata repository 314, a plurality of client devices 308(1) . . . 308(n), and a communication network 310.

In some embodiments, the customer journey reliability device 302 including the customer journey reliability module 306 may be connected to the server 304, the historical metadata database 312, and the historical metadata repository 314 via the communication network 310. The customer journey reliability device 302 may also be connected to the plurality of client devices 308(1) . . . 308(n) via the communication network 310, but the disclosure is not limited thereto. The historical metadata database 312 and the historical metadata repository 314 may include one or more repositories or databases.

In an embodiment, the customer journey reliability device 302 is described and shown in FIG. 3 as including the customer journey reliability module 306, although it may include other rules, policies, modules, databases, or applications, for example. In some embodiments, the historical metadata database 312 and the historical metadata repository 314 may be configured to store ready to use modules written for each API for all environments. Although only one database and one repository are illustrated in FIG. 3, the disclosure is not limited thereto. Any number of desired databases and/or repositories may be utilized for use in the disclosed invention herein. The historical metadata database 312 and the historical metadata repository 314 may be a mainframe database, a log database that may produce programming for searching, monitoring, and analyzing machine-generated data via a web interface, but the disclosure is not limited thereto. In addition, the historical metadata database 312 and the historical metadata repository 314 may store a plurality of data sets and predictive models for ensuring reliability of a customer journey with a platform.

In some embodiments, the customer journey reliability module 306 may be configured to receive real-time feed of data from the plurality of client devices 308(1) . . . 308(n) and secondary sources via the communication network 310.

The customer journey reliability module 306 may be configured to: receive first data that relates to an interaction of a customer with the platform; collect historical metadata that relates to a plurality of reliability-based metrics for each API that relates to the platform; determine, based on the collected metadata, a corresponding threshold metric value for each respective reliability-based metric from among the plurality of reliability-based metrics; compare the first data to each corresponding threshold metric value; when the first data exceeds at least one corresponding threshold metric value: identify, based on a result of the comparing, a corresponding issue; and generate, based on the identifying, an alert.

The plurality of client devices 308(1) . . . 308(n) are illustrated as being in communication with the customer journey reliability device 302. In this regard, the plurality of client devices 308(1) . . . 308(n) may be “clients” (e.g., customers) of the customer journey reliability device 302 and are described herein as such. Nevertheless, it is to be known and understood that the plurality of client devices 308(1) . . . 308(n) need not necessarily be “clients” of the customer journey reliability device 302, or any entity described in association therewith herein. Any additional or alternative relationship may exist between either or both plurality of client devices 308(1) . . . 308(n) and the customer journey reliability device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the customer journey reliability device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The customer journey reliability device 302 may be the same or similar to the customer journey reliability device 202 as described with respect to FIG. 2, including any features or combination of features described with respect thereto.

Upon being started, the customer journey reliability device 302 executes a process for identifying potential reliability issues regarding user interactions within a platform and generating potential actions to address the identified issues.

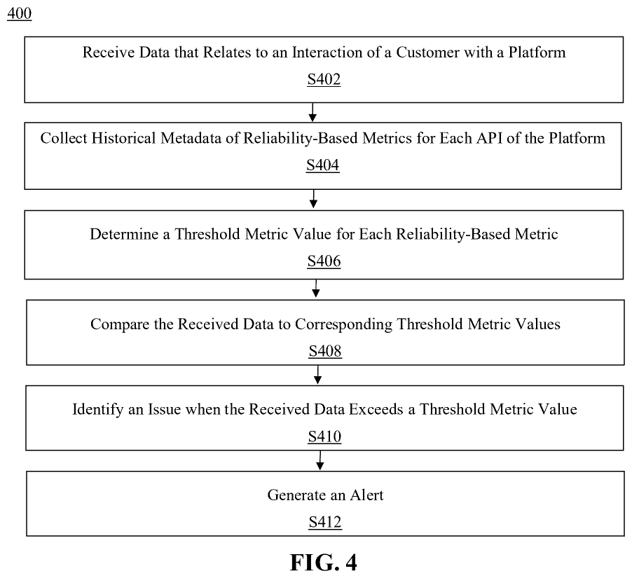

FIG. 4 illustrates a process 400 for identifying potential reliability issues regarding user interactions within a platform and generating potential actions to address the identified issues, according to an embodiment.

In process 400 of FIG. 4, at step S402, the customer journey reliability device 302 may receive data that relates to an interaction of a customer with a platform. In some embodiments, the data may include a plurality of real-time reliability metrics used to measure the speed and/or quality of the customer interaction with the platform. The reliability-based metrics may include at least one from among a response time, an error rate, an availability of the system, a traffic level, a throughput, a latency, a number of insufficient alerts issued, a number of redundant alerts issued, a number of false positives, a number of false negatives, a fault tolerance, a delay tolerance, an uptime, a request rate, a time to detect, a time to respond, and a time to mitigate. In an embodiment, the data may include each respective reliability-based metric for each respective API that is associated with the platform.

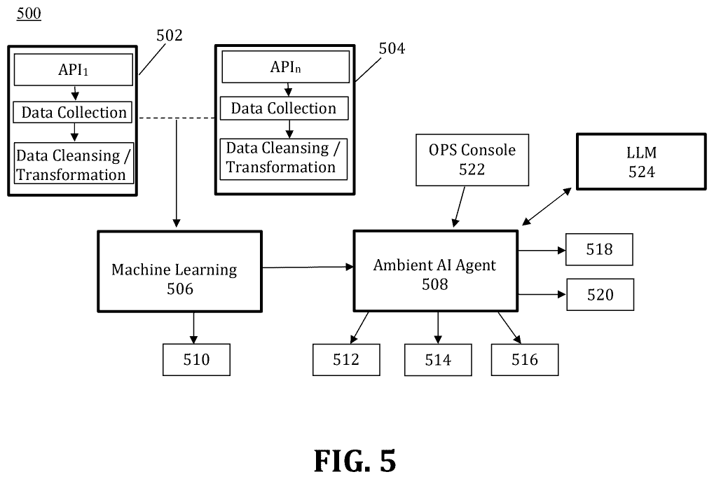

In an embodiment, a customer's interaction with each component of the platform may be monitored and tracked to identify and resolve issues and monitor reliability-based metrics. For example, according to an embodiment, the customer journey reliability device 302 may retrieve a universal trace identification for the interaction of the customer with the customer platform. The universal trace identification may correspond to an identifier of the customer that is recognized by all the APIs associated with the customer platform. The customer journey reliability device 302 may use the universal trace identification to monitor and log the customer's interaction with each API during the interaction of the customer with the platform. For example, according to an embodiment, as further illustrated by FIG. 5, the customer journey reliability device 302 may use at least one service (e.g., ServiceNow, Jira, Bitbucket, internal phone books, and Stack overflow) in conjunction with the universal trace identification to track and log changes and identify the cause or source of an issue.

At step S404, the customer journey reliability device 302 may collect historical metadata of the reliability-based metrics for each API of the platform. The historical metadata may relate to a series of reliability-based metrics over a predetermined period of time. The collected historical metadata may be stored in at least one from among the historical metadata database 312 and the historical metadata repository 314, as illustrated in FIG. 3.

At step S406, the customer journey reliability device 302 may determine a threshold metric value for each reliability-based metric. The threshold metric value may relate to a value in which the respective reliability-based metric is indicative of a critical issue to the API and/or platform. In an embodiment, the threshold metric value may be determined by applying an Isolation Forest algorithm to the collected historical metadata in order to automatically determine the corresponding threshold metric value by constructing at least one decision tree and isolating corresponding outlier data points. The Isolation Forest algorithm may identify anomalies by isolating data points. It may construct decision trees and isolate outliers that have shorter average path lengths compared to normal data points. By analyzing historical data, the Isolation Forest algorithm may automatically set thresholds for various metrics. The customer journey reliability device 302 may analyze historical performance data of API methods to identify patterns and group similar methods together. Additionally, by grouping API methods based on historical data, the customer journey reliability device 302 may set thresholds in a context-aware manner.

In an embodiment, the customer journey reliability device 302 may calculate a corresponding mean and a corresponding standard deviation for each respective reliability-based metric. The threshold metric values may then be calculated by setting a predetermined number of the corresponding standard deviations from the corresponding mean.

At step S408, the customer journey reliability device 302 may compare the received data to a corresponding threshold metric value. For example, according to an embodiment, the customer journey reliability device 302 may compare the real-time platform API response time with the threshold response time of that API to determine if the response time is currently operating within an acceptable range.

At step S410, the customer journey reliability device 302 may identify an issue when the received data exceeds the threshold metric value. For example, according to an embodiment, the customer journey reliability device 302 may identify the API of the platform as having a critical issue if the current response time exceeds the threshold response time for that API. In an embodiment, as further illustrated by FIG. 5, the customer journey reliability device 302 may apply an LLM to extract information regarding the identified issue. The customer journey reliability device 302 may then use the LLM to generate a summary regarding the identified issue based on the extracted information. The customer journey reliability device 302 may also use the LLM to generate an approach or strategy to address the corresponding issue. In some embodiments, the customer journey reliability device 302 may include a GUI that displays each identified issue and a summary of the reliability-based metrics.

Then, at step S412, if an issue is identified, the customer journey reliability device 302 may generate an alert. In an embodiment, the alert may be transmitted to the API owner of the API that is associated with the identified issue. For example, according to an embodiment, the customer journey reliability device 302 may send an email to the API owner stating that there is an issue with the corresponding API. In an embodiment, the customer journey reliability device 302 may apply an LLM to automatically resolve the identified issue.

FIG. 5 illustrates an architectural flow diagram 500 of a process for identifying potential reliability issues regarding user interactions within a platform and generating potential actions to address the identified issues, according to an embodiment. As illustrated by FIG. 5, the customer journey reliability device 302 collects, analyzes, and transforms the reliability-based metric data from each API of the platform at the API data collection modules 502 and 504. While FIG. 5 shows two API data collection modules 502 and 504, any number of desired API data collection modules may be utilized for use in the disclosed invention herein. The cleansed/transformed reliability-based metric data may then be transmitted to the machine learning module 506. The machine learning module 506 may compare the transmitted data to the corresponding threshold metric values. If at least one reliability-based metric value exceeds the corresponding threshold metric value, a correspondence 510 (e.g., email) may be generated for the API owner. The reliability-based metric data processed by the machine learning module 506 may then be transmitted to at least one ambient AI agent 508. The ambient AI agent 508 may not require triggering by a direct message or human interaction. The ambient AI agent 508 may also allow for multiple agents running simultaneously. For example, the ambient AI agent 508 may independently analyze or observe an event and/or data stream and act on it accordingly, without requiring direct instructions from a human. Additionally, the ambient AI agent 508 may act on multiple events or streams at a time. The ambient AI agent 508 may be connected with a plurality of service modules 512, 514, and 516. The service modules 512, 514, and 516 may include key systems for change management (e.g., Snow), issue tracking (e.g., Jira), version control (e.g., Bitbucket), team information (e.g., internal phone book), and community driven solutions (e.g., Stack Overflow). The ambient AI agent 508 may also transmit a correspondence 518 (e.g., email) that includes the reliability-based metric data and/or any identified issue to the API owner. Moreover, the ambient AI agent 508 may also transmit the reliability-based metric data to a GUI 520 for display. Additionally, an operations (OPS) Console 522 may also be connected to the ambient AI agent 508 to enable user control and changes to the ambient AI agent 508. The ambient AI agent 508 may also transmit and receive information from an LLM 524. As noted at Step S410 of FIG. 4, the LLM 524 may extract and process information regarding identified issues, generate summaries of the issues, and determine an approach to address the corresponding issues.

In an embodiment, the customer journey reliability device 302 may implement an AI-driven reliability dashboard to provide a comprehensive and real-time overview of user interactions across various touchpoints. By leveraging advanced analytics and ML algorithms, the customer journey reliability device 302 may predict potential disruptions, identify root causes of reliability issues, and recommend proactive measures to mitigate risks.

In some embodiments, the customer journey reliability device 302 may include a dashboard, which provides a bird's-eye view across all lines of business, applications, teams, and microservices, which may foster collaboration. This dashboard not only identifies potential reliability issues but also facilitates proactive measures to address them, thereby ensuring a seamless user experience. Additionally, this unified approach improves operational efficiency and also ensures a consistent and high-quality user experience.

In an embodiment, the customer journey reliability device 302 may implement AI to provide real-time holistic monitoring of critical customer journeys. By leveraging advanced ML algorithms, the customer journey reliability device 302 may predict potential disruptions, provide actionable insights, and facilitate proactive measures to mitigate issues before they impact customers. The customer journey reliability device 302 may reduce the mean time to detect and mitigate issues, ensuring that critical applications remain available and reliable.

TABLE 1
Six Pillars of Reliability Measures.

| | | Quality | Tolerance | | |
|---|---|---|---|---|---|
| | | Change/ | and Single | | |
| Observability | Optimal | Release | Point of | | Incident |
| Signals | Alerting | Mgmt. | Failure | Idempotence | Response |
| Pillar - 1 | Pillar -2 | Pillar - 3 | Pillar - 4 | Pillar - 5 | Pillar - 6 |
| Measure the | Measure the | Measure a | Measure of | Measure of | Measure of |
| states of the | alerts | change | fault | consistent | time to act |
| system | | | tolerance | response and | on an |
| | | | and point | retries | incident |
| | | | of failure | | |
| 1. Availability | 1. Insufficient | 1. Test | 1. Fault | 1. Reliable | 1. Time to |
| 2. Response | Alerts | Coverage | Tolerance | Response | Detect |
| Time | 2. Redundant | 2. Release | (Multi- | 2. Reliable | 2. Time to |
| 3. Error Rate | Alerts | Gating | region/zone | Retries | Respond |
| 4. Traffic | 3. False | (Required | architecture) | | 3. Time to |
| | Positive | release steps | 2. Delay | | Mitigate |
| | 4. False | followed) | Tolerance | | |
| | Negative | 3. Rollout | (Implement | | |
| | | and Rollback | store and | | |
| | | (Automated | forward) | | |
| | | deployments | 3. Single | | |
| | | and rollback) | Point of | | |
| | | | Failure | | |
| | | | (ensure | | |
| | | | resiliency on | | |
| | | | components) | | |

In an embodiment, the customer journey reliability device 302 may address the complexities of monitoring and ensure the reliability of critical customer journeys in a microservices architecture, by utilizing an AI-driven approach to automate threshold settings. This solution leverages the Isolation Forest algorithm for anomaly detection and employs statistical methods to establish and monitor reliability metrics. The key components of the solution are as follows.
1) Automated Threshold Setting Using Isolation Forest Algorithm: a) Anomaly Detection: the Isolation Forest algorithm is designed to identify anomalies by isolating data points. It works by constructing decision trees and isolating outliers that have shorter average path lengths compared to normal data points. b) Threshold Determination: by analyzing historical data, the Isolation Forest can automatically set thresholds for various metrics. This reduces the manual effort required to define thresholds and ensures that they are dynamically adjusted based on actual data patterns.
2) Grouping of API Methods from Past History: a) Historical Data Analysis: analyze historical performance data of API methods to identify patterns and group similar methods together. This grouping helps in understanding typical behavior and performance characteristics, allowing for more accurate threshold setting. b) Context-Aware Thresholds: by grouping API methods based on historical data, thresholds can be set in a context-aware manner, accounting for the specific characteristics and typical performance of each group.
3) Standard Deviation for Metric Deviation Identification: a) Statistical Analysis: calculate the standard deviation for each of the 19-reliability metrics tracked for every API method. This statistical measure helps in understanding the variability and identifying significant deviations from the norm. b) Deviation Alerts: set up monitoring rules that trigger alerts when metrics deviate beyond a certain number of standard deviations from the mean. This approach ensures that only significant anomalies are flagged, reducing false positives, and focusing attention on critical issues.
4) Tracking 19 Metrics for Reliability Standards: a) Comprehensive Monitoring: track 19 key reliability metrics for each API method. These metrics may include response time, error rates, throughput, latency, uptime, request rates, and more, providing a comprehensive view of the system's health. b) Consistency Across Services: ensure that these metrics are consistently tracked across all services and teams, providing a unified framework for reliability monitoring.
5) Data Collection and Preprocessing: a) collect historical performance data for all API methods. Preprocess the data to remove noise and ensure consistency in logging formats. b) Model Training and Threshold Setting: train the Isolation Forest model using historical data to identify typical behavior and anomalies. Group API methods based on historical performance patterns. Calculate standard deviations for each reliability metric.
6) Deployment and Integration: a) deploy the Isolation Forest model and integrate it with the centralized observability platform. Set up automated processes to adjust thresholds based on model outputs and standard deviation calculations. b) Monitoring and Alerting: implement real-time monitoring dashboards that display the 19-reliability metrics for each API method. Configure alerts to notify relevant teams when metrics deviate beyond set thresholds. c) Continuous Improvement: regularly review and update the Isolation Forest model with new data to improve its accuracy. Adjust grouping criteria and thresholds based on feedback and evolving system behavior.

In an embodiment, the customer journey reliability device 302 may utilize an Isolation Forest algorithm for anomaly detection that is based on the concept of isolating observations. The key idea is that anomalies are few and different, so they are easier to isolate. Listed below is a breakdown of how the Isolation Forest algorithm works and its key formulas.
1. Isolation Trees: an Isolation Forest consists of multiple Isolation Trees. Each tree is constructed by randomly selecting a feature and then randomly selecting a split value between the minimum and maximum values of the selected feature.
2. Isolation Process: the algorithm recursively partitions the data until each observation is isolated. The number of splits required to isolate a point is equivalent to the path length from the root to the leaf.
3. Path Length: For a point (x), the path length (h(x)) in a tree is the number of edges traversed from the root to the leaf. The expected path length (E(h(x))) for a point (x) is given by: [E(h(x))=c(n)].
4. Anomaly Score Calculation: the anomaly score for a point is derived from the average path length over all trees in the forest.
5. Cluster: to group the error statistics, clustering of data is needed.

The authentication device 302 may improve compliance with standards protocols through a regulatory compliance mechanism: using certificates helps in adhering to regulatory requirements for data protection and privacy. Standards like X.509 for certificates and TLS for secure communication are widely recognized and ensure a high level of security compliance.

In some embodiments, the customer journey reliability device 302 may swiftly identify and resolve issues in a complex microservices environment, by integrating various tools and platforms used by development and operations teams. This solution leverages ambient AI agents and ML to automate the identification and resolution of problems by connecting with key systems such as Snow for change management, Jira for issue tracking, Bitbucket for version control, an internal phone book for team information, and Stack Overflow for community-driven solutions. Below is a detailed approach to this integrated solution.

Snow: integrate with Snow software to track changes and identify the specific changes that might have led to an issue. This includes linking change records to the current problem. Jira: connect with Jira to identify the issues related to the current problem, including who resolved the issues and the historical context of similar problems. Bitbucket: integrate with Bitbucket to analyze recent code commits and identify any changes that might be related to the detected issue. This includes code differences and commit messages. Internal Phone Book: use the internal phone book to retrieve information about the team members and managers responsible for the affected services. This helps in quickly assembling the right team to address the issue. Stack Overflow: connect to Stack Overflow to find solutions and code snippets relevant to the identified problem. This crowdsourced information can provide quick fixes and best practices.

In an embodiment, the customer journey reliability device 302 may implement ML for issue identification including by: Anomaly Detection: use ML models like Isolation Forest to detect anomalies in system behavior and identify potential issues; Root Cause Analysis: apply ML techniques to correlate detected anomalies with recent changes in Snow, issues in Jira, and commits in Bitbucket; and Automated Recommendations: use natural language processing (NLP) to extract useful information from Stack Overflow that matches the context of the identified problem.

In some embodiments, the customer journey reliability device 302 may implement an automated workflow by: Real-Time Alerts: when an anomaly is detected, the system generates a real-time alert that includes detailed information about the potential issue; Contextual Information Aggregation: the ambient AI agent may automatically gather contextual information from integrated systems (e.g., Snow, Jira, Bitbucket, phone book, Stack Overflow) and compile a comprehensive report; and Team Notification and Collaboration: notify the relevant team members and managers via email or collaboration tools (e.g., Slack and Microsoft Teams) with all the contextual information needed to address the issue quickly.

In an embodiment, the implementation steps may include: Data Integration: set up data pipelines to pull information from Snow, Jira, Bitbucket, the internal phone book, and Stack Overflow; Model Training and Deployment: train ML models on historical data to accurately detect anomalies and perform root cause analysis; API Development: develop APIs to facilitate communication between the ambient AI agents and the integrated systems for real-time data exchange; and Dashboard and Interface: create a dashboard to display real-time alerts, contextual information, and recommendations. This interface should be user-friendly and accessible to all relevant stakeholders.

In some embodiments, the customer journey reliability device 302 may provide several benefits including: Faster Issue Resolution: by automating the aggregation of contextual information and providing actionable insights, the time to identify and resolve issues is significantly reduced; Improved Collaboration: integrated tools and automated notifications ensure that the right team members are informed and can collaborate effectively to solve problems; Proactive Management: with real-time monitoring and automated analysis, potential issues can be identified and addressed before they impact customers; Enhanced Reliability: the solution ensures that critical customer journeys are continuously monitored and maintained at optimal reliability levels.

Additionally, the technology benefits may include: 1) high availability of applications; 2) insights of customer journey's issues; 3) faster root cause analysis; 4) identify bottle necks and optimize process; 5) holistic view of customer experience; 6) no threshold configuration for monitoring from history, 7) no threshold configuration for monitoring ML model training; 8) decrease time to detect; and 9) decrease time to mitigate.

Moreover, the firm benefits may include: 1) increase NPS score; 2) customer retention; 3) firm reputation; 4) drive efficiency; 5) reduce risk; and 6) save cost.

Thus, by implementing this integrated approach, organizations may leverage AI and ML to swiftly identify and resolve issues, thereby maintaining the reliability and performance of their critical customer journeys. This solution not only enhances operational efficiency but also improves overall customer satisfaction and business performance. Implementing the customer journey reliability device 302 offers several significant benefits for organizations, particularly in the context of reducing issue detection and resolution times, improving system reliability, and enhancing overall business performance. The key benefits are listed below.
1) Drastically Reduced MTTD: Near Zero MTTD: the use of advanced ML models and real-time data integration significantly reduces the MTTD issues from the current average of 15 hours to near zero. This immediate detection allows for faster response and mitigation, thus minimizing the impact on services and customers.
2) Reduced Number of Priority Severity Tickets: Proactive Issue Resolution: by identifying and addressing potential issues before they escalate, the number of priority severity tickets can be substantially reduced. This proactive approach ensures that fewer critical issues reach the stage where they severely impact the system.
3) Decreased Number of Customers Affected: Minimized Impact: faster detection and resolution of issues lead to a significant reduction in the number of customers affected by service disruptions. This enhances customer satisfaction and trust in the reliability of the services provided.
4) Increased Application Uptime: Enhanced Reliability: with continuous monitoring and proactive issue management, application uptime is maintained at high levels. This reliability ensures that critical financial applications and other services remain available to users with minimal downtime.
5) Cost Savings: a) Reduced Operational Costs: lower MTTD and faster issue resolution reduce the operational costs associated with downtime, incident management, and customer support. The automated nature of the solution also decreases the need for extensive manual intervention. b) Prevented Revenue Loss: by maintaining high application uptime and minimizing service disruptions, potential revenue losses due to downtime are avoided, resulting in substantial cost savings for the firm.
6) Improved Business Performance: a) Customer Satisfaction and Retention: higher reliability and fewer disruptions lead to increased customer satisfaction and retention, which are critical for the business's success and growth. b) Competitive Advantage: organizations that can demonstrate superior reliability and quick issue resolution gain a competitive edge in the market, attracting more customers and partners.

Thus, by leveraging the customer journey reliability device 302, organizations can achieve remarkable improvements in the reliability of their critical customer journeys. The reduction in MTTD to near zero, coupled with the decrease in priority severity tickets and affected customers, ensures that applications remain highly available and reliable. These benefits collectively lead to significant cost savings, enhanced customer satisfaction, and improved business performance.

Accordingly, with this technology, an optimized process for identifying potential reliability issues regarding user interactions within a platform and generating potential actions to address the identified issues is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for ensuring reliability of a customer journey with a platform, the method being implemented by at least one processor, the method comprising:
receiving, by the at least one processor, first data that relates to an interaction of a customer with the platform;
collecting, by the at least one processor, historical metadata that relates to a plurality of reliability-based metrics for each application programming interface (API) that relates to the platform;
determining, by the at least one processor based on the collected metadata, a corresponding threshold metric value for each respective reliability-based metric from among the plurality of reliability-based metrics;
comparing, by the at least one processor, the first data to each corresponding threshold metric value;
when the first data exceeds at least one corresponding threshold metric value:
identifying, by the at least one processor and based on a result of the comparing, a corresponding issue; and
generating, by the at least one processor and based on a result of the identifying, an alert.

2. The method of claim 1, wherein the plurality of reliability-based metrics includes at least one from among a response time, an error rate, an availability of the system, a traffic level, a throughput, a latency, a number of insufficient alerts issued, a number of redundant alerts issued, a number of false positives, a number of false negatives, a fault tolerance, a delay tolerance, an uptime, a request rate, a time to detect, a time to respond, and a time to mitigate.

3. The method of claim 1, wherein the determining of the corresponding threshold metric value comprises applying an Isolation Forest algorithm to the collected historical metadata in order to automatically determine the corresponding threshold metric value by constructing at least one decision tree and isolating corresponding outlier data points.

4. The method of claim 1, further comprising:
when the first data exceeds the at least one corresponding threshold metric value, transmitting, by the at least one processor, the alert to a corresponding API owner of a respective API that is associated with the identified corresponding issue.

5. The method of claim 1, further comprising:
when the first data exceeds the at least one corresponding threshold metric value:
applying, by the at least one processor, a large language model (LLM) to extract information regarding the identified corresponding issue;
generating, by the at least one processor via the LLM and based on the extracted information, a summary regarding the corresponding issue; and
generating, by the at least one processor via the LLM, an approach to address the corresponding issue.

6. The method of claim 1, further comprising:
calculating, by the at least one processor, a corresponding mean for each respective reliability-based metric; and
calculating, by the at least one processor, a corresponding standard deviation for each respective reliability-based metric,
wherein the determining of the corresponding threshold metric value comprises setting each corresponding threshold metric value to a predetermined number of the corresponding standard deviations from the corresponding mean.

7. The method of claim 1, further comprising:
retrieving, by the at least one processor, a universal trace identification for the interaction of the customer with the customer platform,
wherein the universal trace identification is recognizable by each API that relates to the customer platform; and
monitoring, by the at least one processor via the universal trace identification, each interaction of the customer with each API during the interaction of the customer with the platform.

8. The method of claim 1, further comprising:
displaying, by the at least one processor via a graphical user interface (GUI), each identified corresponding issue and a summary of the first data that relates to the plurality of reliability-based metrics.

9. The method of claim 1, further comprising:
when the first data exceeds at least one corresponding threshold metric value, applying, by the at least one processor, a large language model (LLM) to automatically resolve the identified corresponding issue.

10. A computing device configured for ensuring reliability of a customer journey with a platform, the computing device comprising:
a processor;
a memory; and
a communication interface coupled to each of the processor and the memory,
wherein the processor is configured to:
receive first data that relates to an interaction of a customer with the platform;
collect historical metadata that relates to a plurality of reliability-based metrics for each application programming interface (API) that relates to the platform;
determine, based on the collected metadata, a corresponding threshold metric value for each respective reliability-based metric from among the plurality of reliability-based metrics;
compare the first data to each corresponding threshold metric value;
when the first data exceeds at least one corresponding threshold metric value:
identify, based on a result of the comparing, a corresponding issue; and
generate, based on a result of the identifying, an alert.

11. The computing device of claim 10, wherein the plurality of reliability-based metrics includes at least one from among a response time, an error rate, an availability of the system, a traffic level, a throughput, a latency, a number of insufficient alerts issued, a number of redundant alerts issued, a number of false positives, a number of false negatives, a fault tolerance, a delay tolerance, an uptime, a request rate, a time to detect, a time to respond, and a time to mitigate.

12. The computing device of claim 10, wherein the determining of the corresponding threshold metric value comprises applying an Isolation Forest algorithm to the collected historical metadata in order to automatically determine the corresponding threshold metric value by constructing at least one decision tree and isolating corresponding outlier data points.

13. The computing device of claim 10, wherein the processor is further configured to:
when the first data exceeds the at least one corresponding threshold metric value, transmit the alert to a corresponding API owner of a respective API that is associated with the identified corresponding issue.

14. The computing device of claim 10, wherein the processor is further configured to:
when the first data exceeds the at least one corresponding threshold metric value:
apply a large language model (LLM) to extract information regarding the identified corresponding issue;
generate, via the LLM and based on the extracted information, a summary regarding the corresponding issue; and
generate, via the LLM, an approach to address the corresponding issue.

15. The computing device of claim 10, wherein the processor is further configured to:
calculate a corresponding mean for each respective reliability-based metric; and
calculate a corresponding standard deviation for each respective reliability-based metric,
wherein the determining of the corresponding threshold metric value comprises setting each corresponding threshold metric value to a predetermined number of the corresponding standard deviations from the corresponding mean.

16. The computing device of claim 10, wherein the processor is further configured to:
retrieve a universal trace identification for the interaction of the customer with the customer platform,
wherein the universal trace identification is recognizable by each API that relates to the customer platform; and
monitor, via the universal trace identification, each interaction of the customer with each API during the interaction of the customer with the platform.

17. The computing device of claim 10, wherein the processor is further configured to display, via a graphical user interface (GUI), each identified corresponding issue and a summary of the first data that relates to the plurality of reliability-based metrics.

18. The computing device of claim 10, wherein the processor is further configured to:
when the first data exceeds at least one corresponding threshold metric value, apply a large language model (LLM) to automatically resolve the identified corresponding issue.

19. A non-transitory computer readable storage medium storing instructions for ensuring reliability of a customer journey with a platform, the storage medium comprising executable code which, when executed by a processor, causes the processor to:
receive first data that relates to an interaction of a customer with the platform;
collect historical metadata that relates to a plurality of reliability-based metrics for each application programming interface (API) that relates to the platform;
determine, based on the collected metadata, a corresponding threshold metric value for each respective reliability-based metric from among the plurality of reliability-based metrics;
compare the first data to each corresponding threshold metric value;
when the first data exceeds at least one corresponding threshold metric value:
identify, based on a result of the comparing, a corresponding issue; and
generate, based on a result of the identifying, an alert.

20. The storage medium of claim 19, wherein the plurality of reliability-based metrics includes at least one from among a response time, an error rate, an availability of the system, a traffic level, a throughput, a latency, a number of insufficient alerts issued, a number of redundant alerts issued, a number of false positives, a number of false negatives, a fault tolerance, a delay tolerance, an uptime, a request rate, a time to detect, a time to respond, and a time to mitigate.
